(19) United States
(12) Patent Application Publication
(10) Pub. No.: US 2017/0331614 A1
(43) Pub. Date: Nov. 16, 2017

(54) SYSTEMS AND METHODS FOR ALIGNING DATA STREAM SIGNALS

(71) Applicant: General Electric Company, Schenectady, NY (US)

(72) Inventor: Ville Petteri Vartiovaara, Helsinki, FL (US)

(21) Appl. No.: 15/152,976

(22) Filed: May 12, 2016

(51) Int. Cl. H04L 7/00

(52) U.S. Cl. CPC H04L 7/0016; H04L 7/0008

(57) ABSTRACT

A system is provided for aligning data stream signals that includes a plurality of end points each having a system clock and a communication circuit. The plurality of end points are configured to generate operation data having a system clock value based on the system clock. The system also includes a first node having a communication circuit configured to be communicatively coupled to the plurality of end points by a bi-directional communication link. The first node receives the operation data from the plurality of end points along the bi-directional communication link. The first node includes a controller circuit configured to determine a clock value and speed offsets between the first node and a first end point. Additionally, the controller circuit is configured to transmit a message sequence to determine the clock value and speed offsets.

### BACKGROUND

The subject matter herein relates generally to systems and methods for aligning data stream signals of one or more sensors within a medical network.

When a patient is admitted into a healthcare facility, the patient is often connected to a plurality of sensors in contact with the patient, such as wearable sensors. The sensors detect and records physiological information (e.g., cardiac activity, breathing activity, electrocardiography (ECG) data, etc.) of the patient. Each sensor may acquire the sensor data within a unique time domain defined by an internal clock, and transmit the sensed data wirelessly to one or more nodes within a medical network.

The medical network can include multiple nodes positioned in one or more locations, which process the sensed data transmitted by the plurality of sensors. However, even if the physiological events (e.g., heart beat) within the sensed data occur within a single “real world” time domain, due to signal processing by the nodes, data transmission between the sensors and the nodes may result in the sensed data arriving at different times. For example, when a data stream traverses through the medical network, both the total latency as well as the unknown variability of the latency (e.g., jitter) increases as the data streams traverse within the medical network. However, it is important that the data streams of the monitoring system originating from the different sensors on the same patient be aligned so that different operations can be reliably applied. To align the data streams the latency of each data stream needs to be known.

Alignment of the data streams by the nodes is not trivial. Conventional medical networks use a standard network time protocol (NTP). The NTP assigns a reference clock of a selected node or server, to represent the clock used for all sensor and nodes within the medical network. The sensors and the alternative nodes within the medical network adjust their internal clocks to match the reference clock by exchanging a plurality of data packets with the selected node. However, the above process according to the NTP can take up to five minutes. Additionally, the above process must be repeated for each new connection. Thus, when a sensor connection is lost and/or connects to a different node sensor, the data stream is stopped and data may be lost to match the sensor to the reference clock.

### BRIEF DESCRIPTION

In an embodiment a system is provided. The system includes a plurality of end points each having a system clock and a communication circuit. The plurality of end points are configured to generate operation data having a system clock value based on the system clock. The system also includes a first node having a communication circuit configured to be communicatively coupled to the plurality of end points by a bi-directional communication link. The first node receives the operation data from the plurality of end points along the bi-directional communication link. The first node includes a controller circuit configured to determine a clock value and speed offsets between the first node and a first end point. Additionally, the controller circuit is configured to transmit a message sequence to determine the clock value and speed offsets.

In an embodiment a method is provided. The method includes generating operation data at a first and second end point. The first and second end points each having a system clock and a communication circuit. The operation data having corresponding system clock values based on the system clocks of the first and second end points, respectively. The method further includes communicatively coupling the first and second end points to a first node. The first node includes a communication circuit configured to be communicatively coupled to the first and second end points, by utilizing a bi-directional communication link. The method also includes transmitting a synchronization instruction from the first node, which is received by the first and second end points. The method further includes receiving the synchronization instruction from the first node, and receiving synchronization responses from the first and second end points. The synchronization responses include synchronization metadata based on the system clocks of the first and second end points. The method further includes determining a first clock value and speed offsets between the first end point and the first node, and a second clock value and speed offsets between the second end point and the first node. The first clock value and speed offsets and the second clock value and speed offsets are based on the synchronization metadata.

In an embodiment a non-transitory computer-readable storage medium having computer executable code is provided. The computer executable code instructing one or more processors to communicatively couple a first end point to a first node. The first node includes a communication circuit configured to be communicatively coupled to the first end point utilizing a bi-directional communication link. The computer executable code further instructing one or more processors to transmit a synchronization instruction from the first node, which is received by a second node, transmit a second synchronization instruction from the second node, which is received by the first end point, determine a latency between receiving the synchronization instruction at the second node, and receive synchronization responses from the first end point. The synchronization response includes synchronization metadata. The first end point having a system clock and a communication circuit. The first end point is configured to additionally transmit operation data having a corresponding system clock value based on the system clock. The computer executable code further instructing one or more processors to determine a clock value and speed offsets between the first end point and the first node based on the synchronization metadata.

### BRIEF DESCRIPTION OF THE DRAWINGS

FIG. 1 is a block diagram of an exemplary medical network in accordance with an embodiment.

FIG. 2 is a schematic block diagram of an end point, in accordance with an embodiment.

FIG. 3 is a schematic block diagram of a node, in accordance with an embodiment

FIG. 4 are graphical representations of data stream signals of a first and second end point, in accordance with an embodiment.

FIG. 5 is a graphical representation of a time synchronization of a first and second end point, in accordance with an embodiment.

FIG. 6 illustrates a message sequence between a selected node, an intermediate node, and an end point, in accordance with an embodiment.

FIG. 7 are graphical representations of aligned data stream signals of the first and second end point shown in FIG. 4, in accordance with an embodiment.

### DETAILED DESCRIPTION

The following detailed description of certain embodiments will be better understood when read in conjunction with the appended drawings. To the extent that the figures illustrate diagrams of the functional modules of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like). Similarly, the programs may be stand-alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Various embodiments described herein include systems and methods for aligning data stream signals and/or system clocks of one or more components (e.g., nodes, end points) within a medical network. The medical network may include a plurality of nodes that may be communicatively coupled to one or more end points and/or one or more other nodes. Each end point may include a system clock defining a sample rate of a data stream signal generated by the end point. For example, the data stream signal may correspond to a series of physiological measurements (e.g., cardiac activity, temperature, breathing rate, and/or the like) of a patient, therapeutic events delivered to the patient, status indicators of the patient, and/or the like. Each system clock of the end point may run independently with respect to each other resulting in data stream signals having different time domains. For example, at least two end points within the medical network may have system clocks that are not aligned.

Optionally, one or more of the nodes of the medical network are communicatively coupled to each other and/or via a cloud server communicatively coupling multiple nodes together. A select node may be utilized by a user and receives a request from a user interface to initialize synchronization and/or alignment of a plurality of data stream signals of a patient. Additionally or alternatively, the select node may initialize synchronization and/or alignment automatically at predetermined intervals. Optionally, the predetermined intervals may be based on the jitter detected based on a preceding synchronization and/or alignment. During the synchronization, the select node may generate and instruct a sequence of time sync query/response events. Based on the responses, the sequence (e.g., 1 to N events), the select node and optionally intermediate nodes (e.g., nodes interposed between the select node and the one or more end points) determine a latency to the “patient skin.” The outcome of the sequence is attached to the respective data stream signals as metadata, allowing for post-processing of arbitrary complexity any time after the sequence has taken place. It may be noted that during the alignment the original data of the data stream signals are not altered, which means that when the network topology changes (e.g., roaming, reconfiguration, offline period, and/or the like), data processing of the data stream signals may go on uninterrupted and/or catch up whenever new time synchronization metadata becomes available. This would not be possible with traditional NTP-type synchronization methods.

A technical effect of the various embodiments include unambiguous time representation, glitch-free operation and continuous, as-good-as-possible stream alignment when the network topology changes while in operation. A technical effect of the various embodiments include maintaining signal quality in a dynamic distributed patient monitoring system.

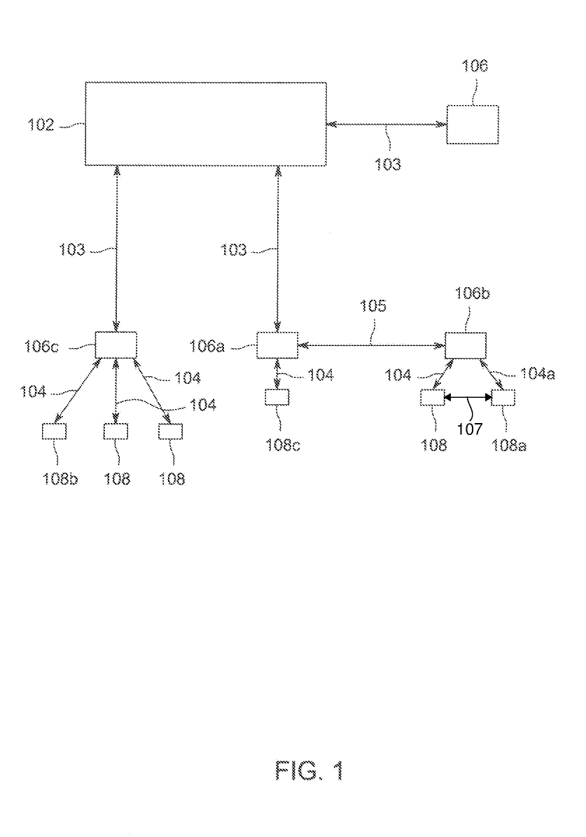

FIG. 1 is a block diagram of an exemplary medical network 100 in accordance with an embodiment. The medical network 100 includes one or more nodes 106 communicatively coupled along a bi-directional communication link 103 to a cloud server 102. Optionally, the one or more nodes 106 (e.g., the nodes 106a and 106b) may form a bi-directional communication link 105 with each other. The communication links 103 and 105 allow the one or more nodes 106 to transmit and/or receive information within the medical network 100 with other nodes 106. In various embodiments, the nodes 106 correspond to access points configured to receive data stream signals generated by one or more end points 108, and/or process, store and/or access the data stream signals. Each of the end points 108 are communicatively coupled along a bi-directional communication link 104 to a corresponding node 106. Optionally, two or more end points 108 may be communicatively coupled directly with each other along a bi-directional communication link 107.

The bi-directional communication links 103-105, 107 allow data to be exchanged between the nodes 106, cloud server 102, and end points 108. For example, the links 103-105, 107 may be based on a wired and/or wireless network protocol (e.g., Wireless Medical Telemetry Service, Medical Body-Area Network, WiFi, 802.11, Bluetooth low energy, Bluetooth, Ethernet, and/or the like), optical communication (e.g., optical fiber, LED pulses, and/or the like), mechanical communication (e.g., pulsed vibrations), and/or the like.

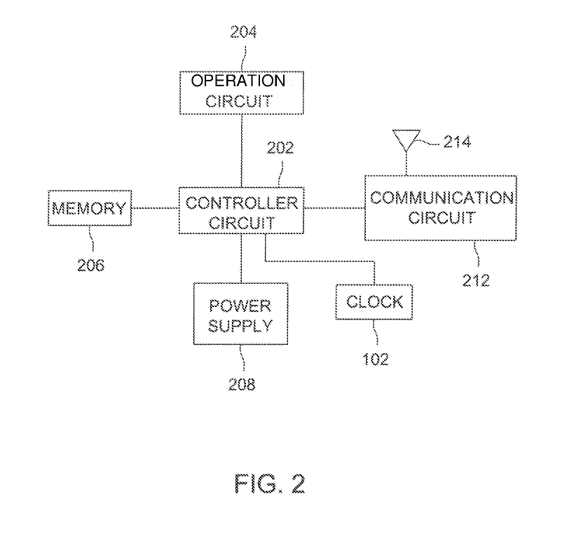

FIG. 2 is a schematic block diagram of the end point 108, in accordance with an embodiment. The end point 108 may be configured to generate one or more data stream signals based on an operation circuit 204. The information within the data stream signals may be based on the type (e.g., sensor, therapeutic, indicator, and/or the like) of the end point 108.

For example, the end point 108 may be a physiological sensor (e.g., electrocardiograph (ECG) sensor, electroencephalograph (EEG), a pulse oximeter, blood pressure monitor, and/or the like) positioned proximate to and/or in contact with a patient, an environmental sensor (e.g., gas sensor, a temperature sensor, and/or the like), a speed sensor, and/or the like. In another example, the end point 108 may be a therapeutic device such as a ventilator, neuro-stimulator, infusion pump, and/or the like. The operation circuit 204 may include one or more amplifiers, multiplexed amplifiers, thermistors, transducers, and/or the like configured to generate an electrical signal. For example, the operation circuit 104 of a sensor type end point may generate an electrical signal representing changes in the environment detected by the operation circuit 204. In another example, the operation circuit 104 of a therapeutic type end point may generate an electrical signal corresponding to therapeutic data (e.g., level of stimulation, anatomy stimulated, type of stimulation) based on stimulation of the patient generated by the operation circuit 204.

The end point 108 may include a power supply 208, such as battery (e.g., lithium-ion battery), solar cell, and/or the like. The power supply 208 may be configured to provide electrical power (e.g., current, voltage) to the components of the end point 108.

The operation circuit 204 is operably coupled to a controller circuit 202, which receives the electrical signal. The controller circuit 202 may be configured to control the functions and/or operation of the end point 108. The controller circuit 202 may include and/or represent one or more hardware circuits or circuitry that include, are connected with, or that both include and are connected with one or more processors, controllers, or other hardware logic-based devices. Additionally or alternatively, the control circuit 202 may execute instructions stored on a tangible and non-transitory computer readable medium (e.g., memory 206) to perform one or more operations as described herein. The controller circuit 202 may digitize the electrical signal generated by the operation circuit 204 based on a system clock 210. The clock 210 includes a crystal oscillator, which is utilized to generate one or more clocking signals which are received by the controller circuit 202. Optionally, the clock 210 may be integrated with and/or apart of the controller circuit 202. The controller circuit 202 may utilize the clock 210 to assign a time corresponding to when the electrical signals of the operation circuit 204 were acquired. For example, the controller circuit 202 may sample the electrical signal at a rate of the clocking signal of the clock 210. Based on the clocking signal and the electrical signal, the controller circuit 202 generates operation data representing a value of the electrical signals at a corresponding time (e.g., sample value) based on the clocking signal. The operation data may include physiological data, therapeutic data, indicator data, and/or the like based on the type of end point 108. The time corresponding to the operation data is based on the clock 210, which represents a time domain of the end point 108. For example, the operation data may have a corresponding internal clock and/or system clock value based on the clock 210 of the end point 108. The operation data may be stored in the memory 206.

The controller circuit 202 may be operably coupled to, and control, a communication circuit 212. The communication circuit 212 may represent hardware that is used to form the bi-directional communication link 104 (FIG. 1). The communication circuit 212 may include a transceiver and associated circuitry (e.g., antennas) 214 for wirelessly communicating (e.g., communicating and/or receiving) with one of the nodes 106 based on a network protocol. For example, protocol firmware may be stored in the memory 206, which is accessed by the controller circuit 202. The protocol firmware provides the network protocol syntax for the controller circuit 202 to assemble data packets, establish the bi-directional communication link 104, and/or partition data received from one of the nodes 106. Additionally or alternatively, the communication circuit 210 may include one or more LEDs transmit and/or a photodetector to detect light for optical communication. Optionally the communication circuit 210 may include an electric motor configured to generate vibrations for mechanical communication.

In various embodiments, the controller circuit 202 may instruct the communication circuit 210 to transmit a data packet that includes operation data representing a measurement signal. The data stream signal may correspond to a series of data packets that are continually transmitted by the communication circuit 210. For example, the communication circuit 210 may transmit the data packets at and/or about a same rate as the clock 210 along the link 104 (FIG. 1). Each data packet corresponding to the data stream signal may include multiple frames based on the network protocol of the link 104. For example, the data packet may include a header that includes network address information of the end point 108 and/or a destination node 106 to receive the data packet (e.g., a select node 106a utilized by the user), timing information (e.g., one or more time stamps), patient information, and/or the like. Additionally, the data packet includes a payload that includes the operation data of the data stream signal, patient information, position of the end point 108 relative to the patient and/or the medical network 100, and/or the like. Additionally or alternatively, the controller circuit 202 may instruct the communication circuit 210 to transmit data packets having operation data at multiple acquisition times periodically. For example, the communication circuit 210 may transmit the operation data packet at a set transmit interval to one of the nodes 106.

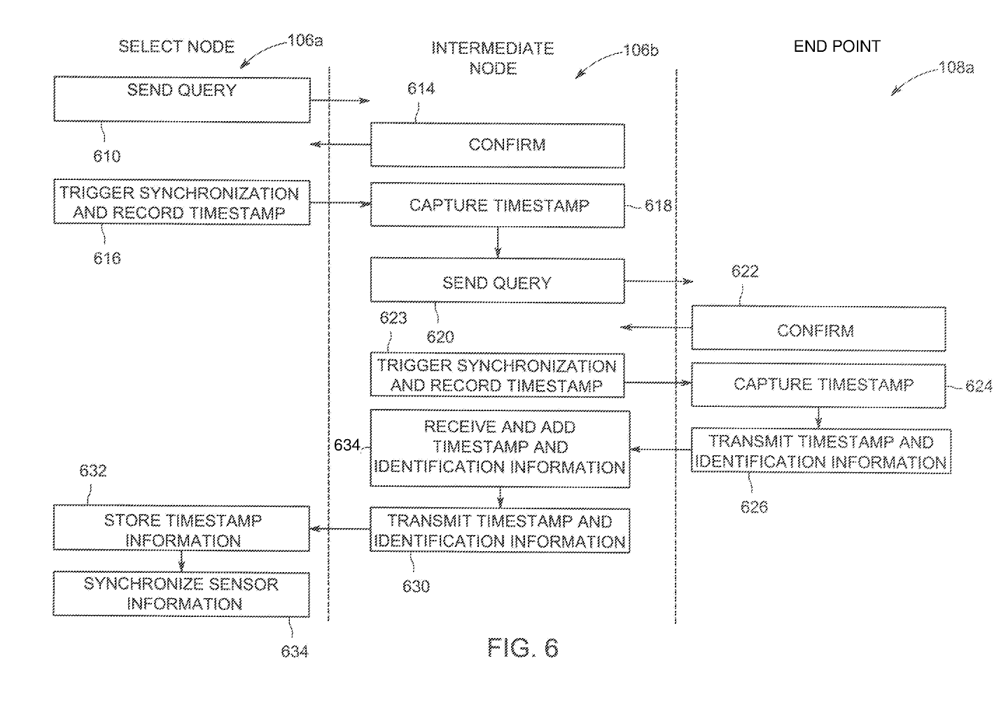

Optionally, the controller circuit 202 may instruct the communication circuit 210 to transmit a data packet that contains time synchronization metadata, referred to as just “synchronization metadata” in this disclosure to separate that data from other types of data. The synchronization metadata may be combined within the same data packet as other data (e.g., within the operation data packet) or be transmitted separately (e.g., as described in connection with FIG. 6).

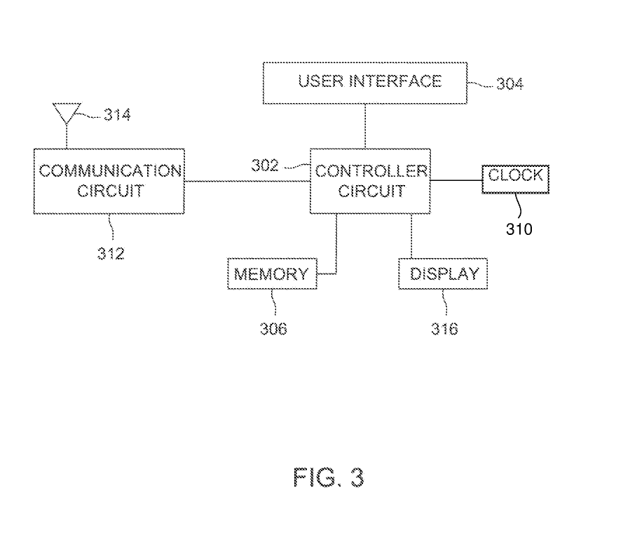

FIG. 3 is a schematic block diagram of one of the nodes 106, in accordance with an embodiment. The node 106 may be configured as an access point capable of receiving and/or transmitting signals from one or more end points 108, alternative nodes 106, and/or the cloud server 102. The node 106 may include a controller circuit 302 configured to control the operation of the node 106. The controller circuit 302 may include and/or represent one or more hardware circuits or circuitry that include, are connected with, or that both include and are connected with one or more processors, controllers, or other hardware logic-based devices. Additionally or alternatively, the controller circuit 302 may execute instructions stored on a tangible and non-transitory computer readable medium (e.g., memory 306) to perform one or more operations as described herein.

The controller circuit 302 may be operably coupled to and control a communication circuit 312. The communication circuit 310 may represent hardware that is used to form the bi-directional communication links 103-105 (FIG. 1). The communication circuit 312 may include a transceiver and associated circuitry (e.g., antennas) 314 for wirelessly communicating (e.g., communicating and/or receiving) with one or more end points 108, alternative nodes 106, and/or the cloud sever 102 based on a network protocol. For example, protocol firmware may be stored in the memory 306, which is accessed by the controller circuit 302. The protocol firmware provides the network protocol syntax for the controller circuit 302 to assemble data packets, establish and/or partition data received along the bi-directional communication links 103-105. Additionally or alternatively, the communication circuit 310 may include one or more LEDs transmit and/or a photodector to detect light for optical communication. Optionally the communication circuit 310 may include an electric motor configured to generate vibrations for mechanical communication.

The node 106 may include a system clock 310 that defines a time domain of the node 106. The system clock 310 includes a crystal oscillator, which is utilized to generate one or more clocking signals which are received by the controller circuit 302. Optionally, the clock 310 may be integrated with and/or apart of the controller circuit 302. The controller circuit 302 may utilize the clock 310 to assign a time corresponding to when operations are performed by the node 106. For example, the controller circuit 302 may utilize the clocking signals of the clock 310 to define timestamps having an internal clock and/or system clock value.

Additionally or alternatively, the controller circuit 302 may be operably coupled to a display 316 and a user interface 304. The display 316 may include one or more liquid crystal displays (e.g., light emitting diode (LED) backlight), organic light emitting diode (OLED) displays, plasma displays, CRT displays, and/or the like. The display 316 may display one or more waveforms based on the data stream signals received from one or more end points 108, treatment information of one or more patients, a list of end points 108 communicatively coupled to the node 106, and/or the like. The user interface 304 controls operations of the controller circuit 302 and is configured to receive inputs from a user. The user interface 304 may include a keyboard, a mouse, a touchpad, one or more physical buttons, and/or the like. Optionally, the display 316 may be a touch screen display, which includes at least a portion of the user interface 304.

For example, a portion of the user interface 304 may correspond to a graphical user interface (GUI) generated by the controller circuit 302, which is shown on the display 316. The GUI may include one or more interface components that may be selected, manipulated, and/or activated by the user operating the user interface 304 (e.g., touch screen, keyboard, mouse). The interface components may be presented in varying shapes and colors, such as a graphical or selectable icon, a slide bar, a cursor, and/or the like. Optionally, one or more interface components may include text or symbols, such as a drop-down menu, a toolbar, a menu bar, a title bar, a window (e.g., a pop-up window) and/or the like. Additionally or alternatively, one or more interface components may indicate areas within the GUI for entering or editing information (e.g., patient information, user information, diagnostic information), such as a text box, a text field, and/or the like.

It may be noted, that in various embodiments at least a portion of the nodes 106 may not have a display 316 and/or user interface 304. For example, at least a portion of the nodes 106 may be a repeater configured to retransmit received data along the bi-directional communication links 103-105.

The controller circuit 302 may perform a time synchronization of a plurality of data stream signals received along the bi-directional communication links 103-105. Optionally, the plurality of data stream signals may be associated with a single patient and/or a select group of patients. The time synchronization may align the plurality of data stream signals having at least two different time domains based on the end points 108. The different time domains of the plurality of data stream signals are based on the nodes 106 and/or the end points 108 having independent system clocks (e.g., operated by the controller circuit 202, 302, derived from the clock 210, and/or the like) with respect to each other. Each system clock has inherent characteristics such as accuracy, drift, jitter, nominal frequency, and/or the like. The differences in time domains between the nodes 106 and/or the end points 108 result in data streams (e.g., the data stream signals) originating from the same physical location (e.g., the patient) having different time stamp values added by the nodes 106 and/or the end points 108 representing the same moment in time. The different time stamp values create an inherent misalignment between the data streams corresponding to a clock value and speed offset.

Additionally, the time domains of the nodes 106 and/or the end points 108 are based on the connection topologies relative to the select node 106a. The connection topographies are based on a different number of intermediate nodes 106 (e.g., node 106b) positioned between the one or more of the end points 108 and the select node 106a. The connection topographies may have different ranges of latencies added to the data stream signals received by the select node 106a. For example, the more intermediate nodes 106 between one of the end points 108 and the select node 106a may add more time domains between the first node and the end point 108c having the bi-directional communication link 104 (e.g., direct link) with the select node 106a. The method (e.g., method 600 in FIG. 6) of synchronization described herein allows for taking into account the additional time domains between the select node 106a and the end point 108c. It may be noted that the method may not rely upon determining the data transmission latency between the end point 108c and the select node 106a, but determines the difference in clock value and speed offset between the end point 108c and the select node 106a.

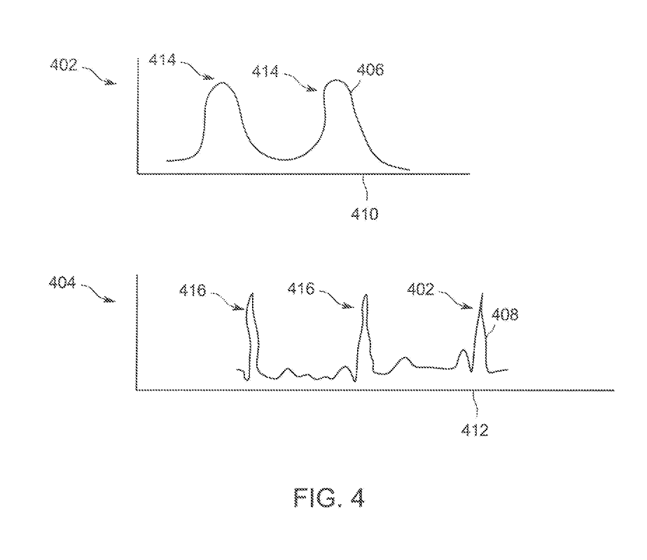

FIG. 4 are graphical representations 402, 404 of data stream signals 406, 408 of a first and second end point 108a, 108b, in accordance with an embodiment. For example, the first end point 108a may generate the data stream signal 406, and the second end point 108b may generate the data stream signal 408. Each of the data stream signals 406, 408 may correspond to a physiological state of a patient in different time domains. For example, the first end point 108a may be a pulse oximeter measuring an oxygen saturation level within the patient, and the second end point 108b may be a cardiac sensor (e.g., ECG) measuring electrical activity of a heart of the patient. The data stream signals 406, 408 are plotted along a horizontal axis 410, 412 based on the time domain of the first and second end points 108a, 108b, respectively. However, due to the differences in time domains the peaks 414 of the data stream signals 406 and the peaks 406 of the data stream signals 408 are aligned relative to each other rather than shifted.

The controller circuit 302 of the select node 106a may align the data stream signals 406, 408 by determining latencies for each of the data stream signals 406, 408 based on information received during the time synchronization operation. It may be noted that the operation data of the data stream signals 406 and 408 does not need to be edited by the controller circuit 302 of the select node 106a in order to align the data stream signals 406 and 408. For example, the controller circuit 302 aligns the data stream signals 406 and 408 by determining a patient acquisition time or patient skin time of when the data stream signals 406 and 408 are generated by the end points 108a and 108b.

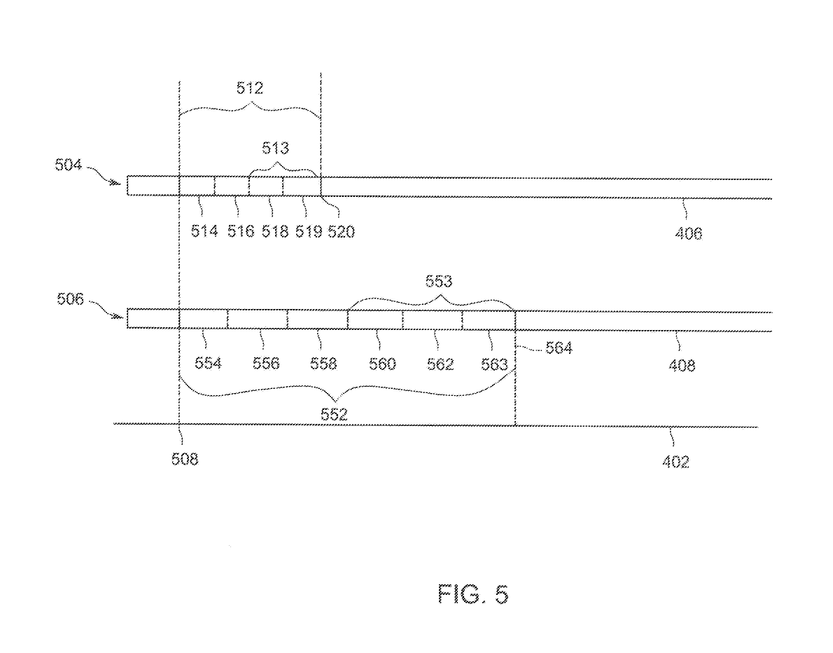

FIG. 5 is a graphical representation 500 of time synchronizations 512, 552 of a first and second end points (e.g., the end points 108a and 108b), in accordance with an embodiment. The graphical representation 500 includes a timing graph 504 corresponding to the end point 108a, and a timing graph 506 corresponding to the end point 108b. The timing graphs 504, 506 are plotted along a horizontal axis 502 representing time. The timing graphs 504, 506 represent a status of the select node 106a. For example, the time graphs 504, 506 include a first portion corresponding to the select node 106a receiving the data stream signals 406, 408, and a second portion corresponding to the select node 106a implementing the time synchronization 512, 552.

The time synchronization 512, 552 starts at 508. For example, at 508 the controller circuit 302 of the select node 106a may detect a selection of the interface component corresponding to the time synchronization operation. In another example, the controller circuit 302 may initiate the time synchronization operation periodically after a predetermined time period. During the time synchronization the controller circuit 302 of the select node 106a may transmit a data packet 514 and 554 containing a synchronization instruction along the bi-directional communication links 103-105. Alternatively or additionally, in connection with the method 600 shown in FIG. 6, the time synchronization operation may be initiated in a form of an electrical trigger, an optical trigger, and/or the like rather than transmitting a data packet.

The data packet and/or trigger signal is re-transmitted at 516 and 556-558 by intermediate nodes 106 (e.g., the intermediate node 106b) and/or the cloud server 102 until the synchronization instruction is received by the end points 108a and 108b. It may be noted, in connection with FIG. 6, that during the trigger events at 616, 618, 623, 624 the controller circuits 202, 302 may capture an internal time value and store the internal time value in the memory 206, 306 to be included in the responses at 634.

The end points 108a and 108b may respond to the synchronization instruction with a data packet 518 and 560 having synchronization metadata based on their internal clocks. The data packet is re-transmitted 519 and 562-563 by the intermediate nodes 106 and/or the cloud server 102 until the synchronization metadata is received by the select node 106a. Upon re-transmitting at 519 and 562-563, each intermediate node 106 may add (cascade) time synchronization metadata of the intermediate node 106 within the data packet being re-transmitted. The synchronization metadata may include the latencies of receiving and re-transmitting the synchronization instructions between the intermediate nodes 106 and the end points 108a and 108b and/or the select node 106a. Additionally or alternatively, the synchronization metadata includes the internal clock value of the end points 108a and 108b when the synchronization instruction is received and/or when a response to the synchronization instruction is transmitted.

Based on the synchronization metadata, the controller circuit 302 of the select node 106a may calculate a clock value and speed offsets between the data stream signals 406 and 408 of the end points 108a and 108b, respectively. For example, the controller circuit 302 of the select node 106a may determine the speed offset based on two subsequent synchronization events. In another example, the controller circuit 302 of the select node 106a may determine the clock value offset between the system clock of the end points 108a, 108b and the system clock of the select node 106a.

In connection with FIG. 6, the message sequence 600 may represent a series of requests transmitted downstream from the select node 106a to the end point 108a, and a series of responses to the requests transmitted upstream from the end point 108a to the select nodes 106a. Based on information within the responses (e.g., the synchronization metadata) of the intermediate nodes 106b and/or end point 108a, the controller circuit 302 of the select node 106a can determine the clock value and speed offsets between the select node 106a and the end point 108a. Additionally or alternatively, the synchronization metadata, when transmitted back to the select node 106a, may be utilized by the controller circuit 306 to determine a load of the medical network 100, latency and/or jitter of transmissions of the end point 108a and/or the intermediate node 106b within the medical network 100, and/or the like.

Additionally or alternatively, the intermediate node 106b and/or end points 108 can be made aware of the determination of the controller circuit 306 of the clock value and speed offsets, allowing for the intermediate node 106b and/or the end points 108 to utilize the synchronization information (e.g., clock value and speed offsets, synchronization metadata, and/or the like). For example, the intermediate nodes 106b and/or the end points 108 may utilize the synchronization information to tune the system clock to a speed and/or frequency proximate to a select end point (e.g., the end point 108a) and/or node (e.g., the select node 106a).

FIG. 6 illustrates the message sequence 600 between the select node 106a, an intermediate node 106b, and an end point 108a, in accordance with an embodiment. The intermediate node 106b may represent an access point to maintain a communication link between the end point 108a and the select node 106a. For example, the intermediate node 106b may transmit data stream signals received by the end point 108a along the link 104 to the select node 106a along the link 105, and/or vice versa. It may be noted that the message sequence 600 may be repeated and/or occur simultaneously or concurrently with more than one node 106 and/or end points 108. For example, the controller circuit 302 of the select node 106a may perform the message sequence 600 for multiple nodes 106 (e.g., additional to the intermediate node 106b) and/or multiple end points 108 (e.g., the end points 108b) of which the select node 106a receives data stream signals (e.g., the data stream signals 408).

Beginning at 610, the select node 106a may transmit a query to the intermediate node 106b. For example, the communication circuit 312 of the select node 106a may transmit the query along the link 105 to the intermediate node 106b. The query may be a data packet configured to instruct the intermediate node 106b to prepare for the time synchronization operation. For example, the query may include patient information on the one or more patients corresponding to the data stream signals to be aligned by the controller circuit 302 of the select node 106a, identification of the one or more end points 108 (e.g., the end point 108a) transmitting the corresponding data stream signals to be aligned, and/or the like. In various embodiments, the query may include a stack of records, such as metadata, for each node 106 and/or end point 108 receiving the query during the time synchronization.

The records may correspond to field categories that are in each data packet transmitted during the time synchronization. The records are updated by the nodes 106 and/or end points 108 within each data packet responding to the time synchronization. The records may be utilized by the controller circuit 302 of the select node 106a to determine a latency between the select node 106a and the one or more end points 108. For example, the records may include a node identification field, timestamp information on when the query was received and/or retransmitted, a hop counter, and/or the like. The hop counter may correspond to a number of devices and/or transmissions needed for the data stream signals generated by the end point 108a to be received by the select node 106a. For example, the hop counter may be incremented for each upstream transmission from the end point 108a to the select node 106a.

At 614, the intermediate node 106b transmits a confirmation receipt of the query. In various embodiments, the confirmation receipt may indicate that the intermediate node 106b is prepared to begin the time synchronization operation. For example, the intermediate node 106b may determine a number of queries (e.g., at 620) for alternative nodes 106 communicatively coupled to the one or more end points 108 transmitting the data stream signals received by the select node 106a, and/or the one or more end points 108 communicatively coupled to the intermediate node 106b transmitted the data stream signals received by the select node 106a.

At 616, the select node 106a may trigger synchronization and record a transmit timestamp of when the trigger is transmitted in the memory 306. The trigger synchronization may correspond to an instruction (e.g., within a data packet) transmitted from the select node 106a to the intermediate node 106b to forward the time synchronization request to alternative nodes 106 and/or end points 108 connected to the intermediate node 106b downstream, such as the end point 108a. The transmit timestamp may correspond to when the synchronization instruction was transmitted by the select node 106a based on an internal system clock of the select node 106a. It may be noted, the events at 616 and 618 allow for an accurate determination of a total latency between the initial event at 610 and the final arrival of the synchronization instruction and the resulting timer capture at 624 of the end point 108a.

Optionally, the transmit timestamp may be stored in a timestamp database. For example, the timestamp database may include a plurality of timestamps each corresponding to the intermediate node 106 and/or end point 108 that the select node 106a transmitted to and/or configured to receive the synchronization downstream from the select node 106a.

At 618, the intermediate node 106b captures and stores a receive timestamp of the trigger synchronization. For example, when the intermediate node 106b receives the synchronization instruction, the intermediate node 106b may record a receive timestamp. The receive timestamp may correspond to when the intermediate node 106b received the synchronization instruction based on an internal system clock of the intermediate node 106b.

At 620, the intermediate node 106b may transmit a query to the end point 108a. For example, when the trigger synchronization is received by the intermediate node 106b, the intermediate node 106b may transmit a query along the link 104a to the end point 108a. The query may be a data packet configured to instruct the end point 108a to prepare for the time synchronization operation. The query may be similar to and/or the same as the query transmitted by the select node 106a at 410.

At 622, the end point 108a transmits a confirmation receipt of the query 412. In various embodiments, the confirmation may indicate that the end point 108a is prepared to begin the time synchronization operation.

At 623, the intermediate node 106b may trigger synchronization and record a transmit timestamp in the memory 306. The trigger synchronization may correspond to an instruction (e.g., within a data packet) transmitted from the intermediate node 106b to the end point 108a to begin the time synchronization. The transmit timestamp may correspond to when the synchronization instruction was transmitted by the intermediate node 106b based on an internal system clock of the intermediate node 106b.

At 624, the end point 108a captures a receive timestamp corresponding to the trigger synchronization. For example, when the end point 108a receives the synchronization instruction, the end point 108a may record a receive timestamp. The receive timestamp may correspond to when the end point 108a received the synchronization instruction based on an internal system clock of the end point 108a.

At 626, the end point 108a transmits a synchronization response that includes the transmit timestamp of the end point 108a and identification information. For example, the end point 108a may construct a data packet representing the synchronization response by providing information (e.g., metadata) to the records within the query transmitted at 620. For example, the metadata may include the receive timestamp, operation data, which includes the acquisition time based on the timing signals of the clock 210, and/or the like. The operation data representing the time domain of the end point 108a. Additionally or alternatively, the end point 108a may increment the hop counter within the metadata of the data packet.

At 628, the intermediate node 106b receives the data packet representing the synchronization response and adds a receive timestamp and identification information. For example, the intermediate node 106b may cascade the metadata of the data packet by adding additional records to the synchronization response to from a cascaded data packet. The additional records may include the receive timestamp, calculating a difference in time between the transmit timestamp (e.g., recorded at 623) and the receive timestamp of the synchronization response, increment the hop counter, and/or the like. Cascading the records at each intermediate node 106b upstream from the end point 108b provides latency information between each bi-directional communication link 103-105 utilized to communicatively couple the select node 106a to the end point 108a. Optionally, the intermediate node 106 may store the synchronization response of the end point 108a within a timestamp database in the memory 306.

At 630, the intermediate node 106b transmits cascaded data packet representing the updated synchronization response (e.g., includes the transmit timestamp of the intermediate node 106b and identification information) to the select node 106a.

At 632, the select node 106a receives the cascaded data packet representing the updated synchronization response from the intermediate node 106b, and stores the timestamp information in the memory 306. For example, the controller circuit 302 of the select node 106a my partition the records within the synchronization response to extract the timestamp information of the end point 108a, the intermediate node 106b, a time stamps of when the select node 106a received the cascaded data packet, and/or the like in the memory 306.

At 634, the controller circuit 302 of the select node 106a synchronizes the data stream signals based on the updated synchronization response. For example, the control circuit 302 may calculate a latency 513 for the end point 108a based on the difference in time stamps recorded by the select node 106a. The latency 513 representing an amount of time between the transmission of the data stream signals 406 until being received by the select node 106a. Optionally, the latency represents an amount of time between transmission of the time synchronization instruction at 616 by the select node 106a and when the capture (or similar event) at 624 is performed by the end point 108a. Based on the latency 513 and acquisition time (e.g., sample value) of the received operation data, the controller circuit 302 can align the data stream signal 406 of the end point 108a with other data stream signals (e.g., the data stream signal 408) received by the select node 106a.

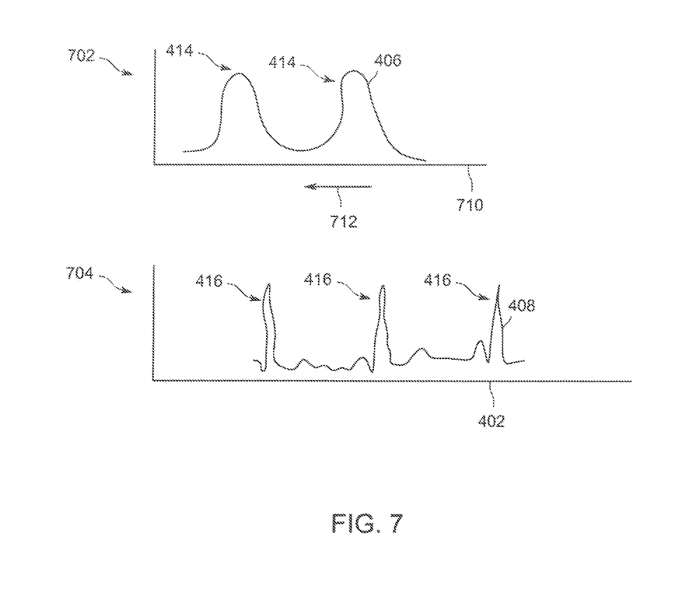

For example, the updated synchronization response for the end point 108b may include operation data having a sample value of 564. As illustrated in FIG. 5, a latency 553 of the data stream signal 408 is longer and/or greater than the latency 513. The controller circuit 302 may align the data stream signals 406 and 408 with operation data of the data stream signal 406 received at calculated time based on a difference in latency lengths prior to receipt of the operation data of the data stream signal 408. For example, in connection with FIG. 7, the controller circuit 302 may shift the data stream signal 406 based on the difference in latency between the end point 108a and 108b to form graphical representations 702 and 704 of the data stream signals 406, 408 of a first and second end point (e.g., the end point 108a, 108b), in accordance with an embodiment.

FIG. 7 are the graphical representations 702, 704 of aligned data stream signals 406, 408 of the first and second end point (e.g., the end point 108a, 108b) shown in FIG. 4, in accordance with an embodiment. The controller circuit 302 may adjust the horizontal axis 410 representing to time based on the difference in latency. For example, shift in a direction of the arrow 712 to form the horizontal axis 710. Based on the adjustment, the data stream signals 406 and 408 are aligned.

The latencies between the transmission and receipt of the trigger between 616 and 618, and 623 and 624 can be included when calculating the latency 513. For example, a delay can be present between the transmission of the trigger at 616 and when the trigger is visible and/or received by the intermediate node 106b at 618. The controller circuit 302 of the select node 106a may include the delay to calculated latency between, for example, the events at 616 and 618.

It may be noted that one or more of the operations of the message sequence 600 shown in FIG. 6 may be included into the operation of the bi-directional communication links 103-105 and not be separate events by itself. For example, one or more of the nodes 106, such as the select node 106a, may transmit beacons (e.g., RF link beacons) along the bi-directional communication links 103-105 to alternative nodes 106 and/or end points 108 as triggers to capture timing information, such as latency information from prior synchronization and/or alignment operations, prior time stamps, and/or the like. The transmit beacons may be periodically transmitted after a predetermined interval.

Additionally or alternatively, at 634 the controller circuit 302 of the select node 106a synchronizes the data stream signals by determining the offsets (e.g., the clock value and speed offsets) between the time domains of the select end point 108a and the select node 106a at a given time and/or a difference in clock frequencies between the respective system clocks of the select end point 108a and the select node 106a. For example, the controller circuit 302 determines the variables a and b of Equation 1, which is used by the controller circuit 302 to translate and/or transform a timestamp or time domain of the select end point 108a to the time domain (e.g., a timestamp value) of the select node 106a. The variables a and b correspond to the misalignment between the time domains of the select node 106a and the select end point 108a.

Timestamp_host=a·Timestamp_endpoint+b (Equation 1)

The variable Timestamp_host may represent a timestamp value of the select node 106a. The variable Timestamp_endpoint may represent a timestamp value at the select end point 108a. Additionally or alternatively, the variable Timestamp_host may represent a timestamp value of a select component utilized and/or selected by the user, and the variable Timestamp_endpoint may represent a timestamp value of an alternative component selected by the user that the select component receives data (e.g., operation data) from. The variable a represents a frequency difference (as a unitless factor) between the select node 106a and the select end point 108a. The variable b represents an offset (e.g., in timestamp counts of the select node 106a) between the select node 106a and the select end point 108a. It may be noted that the offset, the variable b, does not represent a flight time (e.g., latency) between the select node 106a and the select end point 108a. Based on the updated synchronization response, the controller circuit 302 of the select node 106a may determine the variables a and b for the select end point 108a, and align or re-sample the data stream signals received from the select end point 108a. Additionally or alternatively, the controller circuit 302 of the select node 106a may determine the variables a and b for one or more alternative components (e.g., the end point 108b) within the network 100 by repeating the method 600.

Additionally or alternatively, the select node 106a may transmit the calculated variables a and b to other components (e.g., nodes 106, end points 108) within the network 100. For example, the select node 106a may transmit to the select end point 108a the calculated variables a and b for the select end point 108a, and the calculated variables a and b for the senor 108b. Based on the received a and b variables for both end points 108a-b, the controller circuit 202 of the select end point 108a may be able to interpret or align the time information of the data stream signals of the end point 108b within the time domain of the select end point 108a.

Additionally or alternatively, one or more components (e.g., nodes 106, end points 108) within the network may synchronize and/or align system clocks with each other based on the calculated variables a and b. For example, the select node 106a may transmit to the select end point 108a the calculated variables a and b for the select end point 108a, and the calculated variables a and b for the senor 108b. Based on the received a and b variables for both end points 108a-b, the controller circuit 202 of the select end point 108a may be able to align the system clock time information of the data stream signals of the end point 108b within the time domain of the select end point 108a.

In an embodiment a system is provided. The system includes a plurality of end points each having a system clock and a communication circuit. The plurality of end points are configured to generate operation data having a system clock value based on the system clock. The system also includes a first node having a communication circuit configured to be communicatively coupled to the plurality of end points by a bi-directional communication link. The first node receives the operation data from the plurality of end points along the bi-directional communication link. The first node includes a controller circuit configured to determine a clock value and speed offsets between the first node and a first end point. Additionally, the controller circuit is configured to transmit a message sequence to determine the clock value and speed offsets.

Optionally, the first node includes a system clock. The controller circuit may be configured to align the system clock of the first node with the system clock of the end point based on the clock value and speed offsets.

Optionally, the controller circuit is configured to align the operation data based on the clock value and speed offsets.

Optionally, the clock value and speed offsets represent an amount of difference in clock value and operating frequency between the first end point and the first node.

Optionally, the plurality of end points generate a synchronization response based on the message sequence. The synchronization response may have a time stamp based on a system clock of the plurality of end points. The system clock of the plurality of end points being different than the system clock of the first node. Additionally or alternatively, an intermediate node receives the synchronization response and forms a cascade data packet from the synchronization response.

Optionally, the system includes a second node, wherein the bi-directional communication link is between the first node and the second node.

Optionally, the operation data includes physiological data or therapeutic data of a patient.

Optionally, at least a portion of the plurality of end point are in contact with a patient.

In an embodiment a method (e.g., for aligning data stream signals) is provided. The method includes generating operation data at a first and second end point. The first and second end points each having a system clock and a communication circuit. The operation data having corresponding system clock values based on the system clocks of the first and second end points, respectively. The method further includes communicatively coupling the first and second end points to a first node. The first node includes a communication circuit configured to be communicatively coupled to the first and second end points, by utilizing a bi-directional communication link. The method also includes transmitting a synchronization instruction from the first node, which is received by the first and second end points. The method further includes receiving the synchronization instruction from the first node, and receiving synchronization responses from the first and second end points. The synchronization responses include synchronization metadata based on the system clocks of the first and second end points. The method further includes determining a first clock value and speed offsets between the first end point and the first node, and a second clock value and speed offsets between the second end point and the first node. The first clock value and speed offsets and the second clock value and speed offsets are based on the synchronization metadata.

Optionally, the method includes aligning a system clock of the first node with the system clock of the first end point based on the first clock value and speed offsets or the second end point based on the second clock value and speed offsets.

Optionally, the method includes further comprising aligning the operation data based on the first signals based on the first clock value and speed offsets and the second clock value and speed offsets.

Optionally, the method includes establishing a first bi-directional communication link between the first node and a second node, and establishing a third bi-directional communication link between the second node and at least one of the first end point or the second end point. Additionally or alternatively, further comprising forming a cascade data packet at the second node based on the synchronization response.

Optionally, the method includes transmitting a query from the first node, wherein the query includes metadata fields. Additionally or alternatively, the metadata fields includes at least one of a node identification field, timestamp information field, or a hop counter.

Optionally, the synchronization response includes a time stamp based on the system clock of the first and second end points. The system clock of the first and second end points may be different than a system clock of the first node.

Optionally, the operation data includes physiological data or therapeutic data of a patient.

In an embodiment a non-transitory computer-readable storage medium having computer executable code is provided. The computer executable code instructing one or more processors to communicatively couple a first end point to a first node. The first node includes a communication circuit configured to be communicatively coupled to the first end point utilizing a bi-directional communication link. The computer executable code further instructing one or more processors to transmit a synchronization instruction from the first node, which is received by a second node, transmit a second synchronization instruction from the second node, which is received by the first end point, determine a latency between receiving the synchronization instruction at the second node, and receive synchronization responses from the first end point. The synchronization response includes synchronization metadata. The first end point having a system clock and a communication circuit. The first end point is configured to additionally transmit operation data having a corresponding system clock value based on the system clock. The computer executable code further instructing one or more processors to determine a clock value and speed offsets between the first end point and the first node based on the synchronization metadata.

Optionally, the computer executable code further establishes the first bi-directional communication link between the first node and the second node.

It should be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid-state drive, optical disk drive, and the like. The storage device may also be other similar means for loading computer programs or other instructions into the computer or processor.

As used herein, the term “computer,” “subsystem,” “circuit” or “module” may include a processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term computer,” “subsystem,” “circuit” or “module”. The one or more processors execute a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments. The set of instructions may be in the form of a software program. The software may be in various forms such as system software or application software and which may be embodied as a tangible and non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein. Instead, the use of “configured to” as used herein denotes structural adaptations or characteristics, and denotes structural requirements of any structure, limitation, or element that is described as being “configured to” perform the task or operation. For example, a controller circuit, processor, or computer that is “configured to” perform a task or operation may be understood as being particularly structured to perform the task or operation (e.g., having one or more programs or instructions stored thereon or used in conjunction therewith tailored or intended to perform the task or operation, and/or having an arrangement of processing circuitry tailored or intended to perform the task or operation). For the purposes of clarity and the avoidance of doubt, a general purpose computer (which may become “configured to” perform the task or operation if appropriately programmed) is not “configured to” perform a task or operation unless or until specifically programmed or structurally modified to perform the task or operation.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f) unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal language of the claims.

What is claimed is:

1. A system comprising:
a plurality of end points each having a system clock and a communication circuit, wherein the plurality of end points are configured to generate operation data having a system clock value based on the system clock; and
a first node having a communication circuit configured to be communicatively coupled to the plurality of end points by a bi-directional communication link, wherein the first node receives the operation data from the plurality of end points along the bi-directional communication link, the first node includes a controller circuit configured to determine a clock value and speed offsets between the first node and a first end point, wherein the controller circuit is configured to transmit a message sequence to determine the clock value and speed offsets.

2. The system of claim 1, wherein the first node includes a system clock, the controller circuit configured to align the system clock of the first node with the system clock of the end point based on the clock value and speed offsets.

3. The system of claim 1, wherein the controller circuit is configured to align the operation data based on the clock value and speed offsets.

4. The system of claim 1, wherein the clock value and speed offsets represent an amount of difference in clock value and operating frequency between the first end point and the first node.

5. The system of claim 1, wherein the plurality of end points generate a synchronization response based on the message sequence, the synchronization response having a time stamp based on the system clock of the plurality of end points, the system clock of the plurality of end points being different than a system clock of the first node.

6. The system of claim 5, wherein an intermediate node receives the synchronization response and forms a cascade data packet from the synchronization response.

7. The system of claim 1, further comprising a second node, wherein the bi-directional communication link is between the first node and the second node.

8. The system of claim 1, wherein the operation data includes physiological data or therapeutic data of a patient.

9. The system of claim 1, wherein at least a portion of the plurality of end points are in contact with a patient.

10. A method comprising:
generating operation data at a first and second end point, the first and second end points each having a system clock and a communication circuit, wherein the operation data having corresponding system clock values based on the system clocks of the first and second end points, respectively;
communicatively coupling the first and second end points to a first node, wherein the first node includes a communication circuit configured to be communicatively coupled to the first and second end points utilizing a bi-directional communication link;
transmitting a synchronization instruction from the first node, which is received by the first and second end points;
receiving the synchronization instruction from the first node;
receiving synchronization responses from the first and second end points, wherein the synchronization responses include synchronization metadata based on the system clocks of the first and second end points; and
determining a first clock value and speed offsets between the first end point and the first node, and a second clock value and speed offsets between the second end point and the first node, wherein the first clock value and speed offsets and the second clock value and speed offsets are based on the synchronization metadata.

11. The method of claim 10, further comprising aligning a system clock of the first node with the system clock of the first end point based on the first clock value and speed offsets or the second end point based on the second clock value and speed offsets.

12. The method of claim 10, further comprising aligning the operation data based on the first signals based on the first clock value and speed offsets and the second clock value and speed offsets.

13. The method of claim 10, further comprising establishing a first bi-directional communication link between the first node and a second node; and
establishing a third bi-directional communication link between the second node and at least one of the first end point or the second end point.

14. The method of claim 13, further comprising forming a cascade data packet at the second node based on the synchronization response.

15. The method of claim 10, further comprising transmitting a query from the first node, wherein the query includes metadata fields.

16. The method of claim 15, wherein the metadata fields includes at least one of a node identification field, timestamp information field, or a hop counter.

17. The method of claim 10, wherein the synchronization response includes a time stamp based on the system clock of the first and second end points, the system clock of the first and second end points being different than a system clock of the first node.

18. The method of claim 10, wherein the operation data includes physiological data or therapeutic data of a patient.

19. A non-transitory computer-readable storage medium having computer executable code to:
communicatively couple a first end point to a first node, wherein the first node includes a communication circuit configured to be communicatively coupled to the first end point utilizing a bi-directional communication link;
transmit a synchronization instruction from the first node, which is received by a second node;
transmit a second synchronization instruction from the second node, which is received by the first end point;
determine a latency between receiving the synchronization instruction at the second node;
receive synchronization responses from the first end point, wherein the synchronization response includes synchronization metadata, the first end point having a system clock and a communication circuit, wherein the first end point is configured to additionally transmit operation data having a corresponding system clock value based on the system clock; and
determine a clock value and speed offsets between the first end point and the first node based on the synchronization metadata.

20. The non-transitory computer-readable storage medium of claim 17, wherein the computer executable code further establishes the first bi-directional communication link between the first node and the second node.
